(19) United States
(12) Patent Application Publication
(10) Pub. No.: US 2015/0067832 A1
(43) Pub. Date: Mar. 5, 2015

(54) Client Side Phishing Avoidance

(71) Applicant: Cisco Technology, Inc., San Jose, CA (US)

(72) Inventor: Venkateshwara Sastry, Bangalore (IN)

(73) Assignee: Cisco Technology, Inc., San Jose, CA (US)

(21) Appl. No.: 14/015,320

(22) Filed: Aug. 30, 2013

(51) Int. Cl. G06F 21/55

(52) U.S. Cl. CPC G06F 21/552
USPC 726/22

(57) ABSTRACT

In one implementation, a phishing scam involves a communication sent to a user by an impersonator. Rather than detect the communication and verify the identity of the sender, the data entry of the user is monitored. For example, an example embodiment scans data entry from a user for a security word and queries a list of authorized terms for the security word. In response to the security word being included in the list of authorized terms, a destination address associated with the security word is identified. A list of authorized destination addresses is queried with the destination address associated with the security word.

### TECHNICAL FIELD

This disclosure relates in general to the field of network security, and more specifically, to avoidance of unauthorized requests for secure information.

### BACKGROUND

In phishing scams, an unauthorized entity masquerades as a trustworthy entity. The trustworthy entity may be any online service such as a bank, a social networking service, a credit card, a merchant or another service. The phishing scam may take many forms. For example, a communication that purports to be from the trustworthy entity may be sent from the unauthorized entity to a user.

The communication may be an email, an instant message, a request from a website, or another prompt. The communication may request that the user enter a login and password, which may be used by the unauthorized entity to gain access to the user's data, accounts, storage space, or other resources. The request may be phrased in terms such as “please verify your account information” and prompt the user with a familiar but counterfeit interface. Unsuspecting users may provide their login and password, which compromises the security of the user's account.

### BRIEF DESCRIPTION OF THE DRAWINGS

Exemplary embodiments of the present embodiments are described herein with reference to the following drawings.

FIG. 1 illustrates an example system for phishing avoidance.

FIG. 2 illustrates another example system for phishing avoidance.

FIG. 3 illustrates an example computing device of the system of FIG. 1.

FIG. 4 illustrates an example flow chart for phishing avoidance using the computing device of FIG. 3.

### DESCRIPTION OF EXAMPLE EMBODIMENTS

### Overview

In one embodiment, a method includes scanning data entry from a user for a security word, querying a list of authorized terms for the security word, identifying, in response to the security word being included in the list of authorized terms, a destination address associated with the security word, and querying a list of authorized destination addresses with the destination address associated with the security word.

### Example Embodiments

A phishing scam may involve a link in an email or other communication that appears to belong to a trustworthy entity. Some phishing attempts may include a slightly misspelled uniform resource locator (URL). Some phishing attempts may include a strategic use of subdomains such as http://www.companyname.example.com/, which may appear to be associated with “companyname” but actually points to a specific section of the example.com website that is named “companyname”. Unsuspecting users may provide personal information to these or other types of impersonations or phishing scams.

The following embodiments may include a security agent to monitor the data entry of a user to identify potential passwords, PINs, usernames, or other login information to flag a potential login attempt and verify that the website, computer, or network associated with the potential login attempt is a known entity or otherwise approved for secure connections with the user. For example, the security agent may parse data traffic to identify specific types of packets. For example, the security agent may detect HTTP POST events and parse data from the HTTP post events to identify usernames, passwords, PINs, or other credentials.

Consider an example in which a user accesses the website “www.bank.com” with a browser. The security agent for the user scans data as entered by a user. When any data entered by the user matches any of the password, login, or credential columns of the lookup table, the security agent detects the current URL of the browser. If the current URL matches the URL in the lookup table, no alert is generated, the transaction is permitted to be forwarded to the trusted URL, and the data entry may be logged. If the current URL does not match the URL in the lookup table, an alert is generated. The alert may inform the user of a possible security violation. The alert may inform the trusted URL from the lookup table of the possible security violation. The security agent run by the user may prevent others from obtaining security information by phishing.

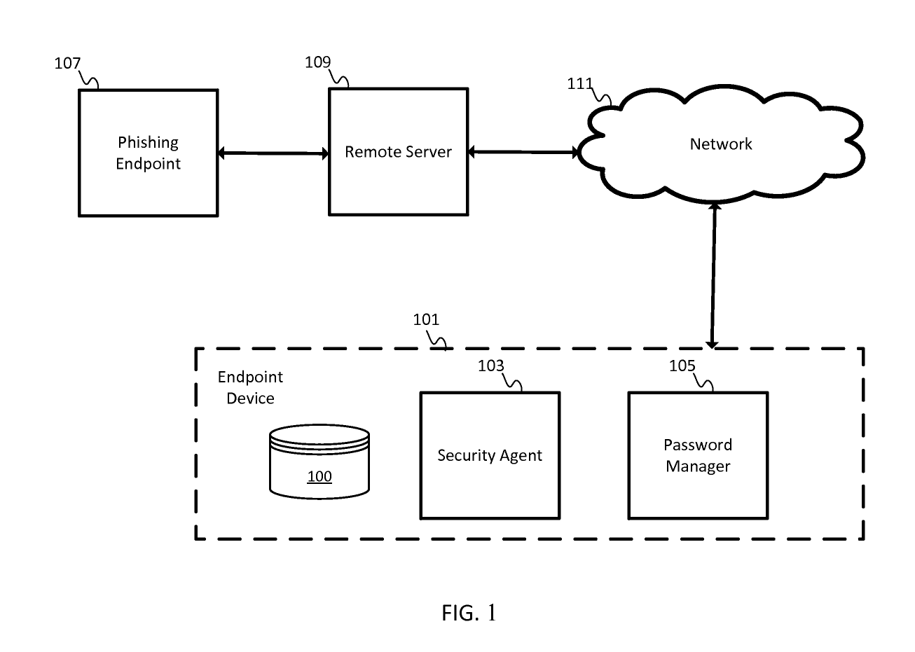

FIG. 1 illustrates an example system for phishing avoidance. The system includes an endpoint device 101 having a database 100, a security agent 103, and a password manager 105. The endpoint device 101 is coupled with a network 111. Also coupled to the network 111 are a remote server 109 and/or a phishing endpoint 107. The endpoint device 101 is a user device. The phishing endpoint 107 is another endpoint that purports to be a secure device accessible from the user device. The endpoint device 101 and/or the phishing endpoint 107 may be a computer, a laptop, a tablet, a smart phone, or any computing device including at least a memory and a processor. Additional, different, or fewer components may be provided. The phrase “coupled with” is defined to mean directly connected to or indirectly connected through one or more intermediate components. Such intermediate components may include hardware and/or software-based components.

The password manager 105 includes software or a computer executing software that builds and manages login information for a user. The login information may include any personal information entered by the user at the endpoint device 101 in order to access a remote system. The remote system may be accessed through a website, a mobile application, a virtual private network, telnet, or a transfer protocol application. The transfer protocol application may include hypertext transfer protocol, file transfer protocol, or another example protocol. The remote system may be a social networking service, an email server, a banking service, an electronic commerce retailer, or another example. The personal information may include any combination of passwords, PINs, usernames, credentials, a number entered from a hardware token (e.g., SecurID), a security or access question answer, or other login information. The password may store the personal information for the known remote systems as a list of authorized terms in database 100.

The password manager 105 may also include a password autocomplete application as software or a computer executing software that organizes passwords and/or personal identification numbers (PINs). A database may associate passwords with various usernames, websites, computers, or networks. The password autocomplete application completes the login information to access the websites, computers, or networks. In one example, the password autocomplete application automatically fills in forms that are labeled as user and password. The password manager 105 is a standalone component or is incorporated into other software, such as being part of an anti-virus software or part of browser software.

The security agent 103 is software or a computer or other hardware executing the software that scans or monitors data entry of the user in search of personal information. The security agent 103 is independent of, communicates with, or is incorporated as part of the password manager 105. The portion of the data entry of the user identified as personal information may be referred to as security words. Security words are specific examples of data entered by a user to access the remote system. A security word may be any alphanumeric text, including only numbers or symbols. The security agent 103 may be configured to identify security words from the data entry by comparing all data entry to the list of authorized terms or a compilation of personal information stored in the database 100. The data entry may be any or all data entry by a user that is to be transmitted over the network 111, including auto-completed entries. All data entered by the user that is to be transmitted over the network 111 may be referred to as user data entry. The security agent 103 and the password manager 105 may be desktop software running on the endpoint device 101 in the same application or different applications.

The data entry of the user may be monitored or scanned in various techniques. In one technique, all data entry is monitored. In an alternative embodiment, only selected portions of the data entry is examined for security words. For example, the security words may be identified based on a field label, flags, or other identifiers. The login fields are identified and data entry into the login fields is monitored. The login fields may be identified by an identifier such as a flag or a label. Example flags or labels include “/username,”<login>, or another indication of the placement of the security word. The data entry may be recorded in memory or the database 100.

When a match is found between any item in the list of authorized terms and the data entry, the data entry is further scrutinized. The additional scrutiny may include analyzing the address, a domain or a URL on the other end of the web transaction or data entry to verify whether it is a trusted address. For example, the database 101 may include a trusted address lookup table:

| Trusted Address | Password | Login | Other credential |
|---|---|---|---|
| www.bank.com | G0d8Y3jr | Asmith | |
| www.socialdiary.com | Helloworld | Happy123 | Dinomite.epf |
| www.wireless.com | 543hnrtg | 3125551234 | |
| www.creditcard.com | Happ123 | Adamsmith | Hometown |

Each entry in the trusted address lookup table identifies a trusted address and at least one personal identification item. The trusted address lookup table may be a policy established by the password manager 105.

The endpoint device 101, via the security agent 103, is configured to identify a destination address associated with the currently entered security word. This may be a phishing address unknown as such to the user. The identification is in response to the security word being included in the list of authorized terms. The destination address identifies the remote server 109 and/or a phishing endpoint 107 that is associated with the data entry that included the security word. The destination address may be an internet protocol (IP) address, media access control (MAC) address, or a URL.

The endpoint device 101, via the security agent 103, is configured to query a list of authorized destination addresses (e.g., the trusted address lookup table) with the destination address associated with the security word. When the destination address associated with the security word is included in the list of authorized destination addresses, data traffic including the security word is forwarded to the destination address (e.g., remote server). When the destination address associated with the security word is omitted from the list of authorized destination addresses, a warning message is generated by the security agent 103. The warning message may be displayed on the endpoint device 101 or sent to a monitoring device. The monitoring device may be operated by a network provider or a security as a service server. In another example, the warning message may be a tag inserted into the data entry or associated web transaction. The tag identifies the data entry or associated web transaction as a security violation or a potential security violation.

The list of authorized destination addresses may also include supplemental information related to the history of the trusted addresses. The supplemental information may include a time elapsed since the trusted address was accessed by the user, the number of total attempts to securely login to the trusted address, the number of attempts to securely login over a time period (e.g., 1 day, 1 week, 1 month, or another length of time), the number of successful secure connections with the trusted addresses in total or over a time period, or another statistic for the trusted address. Alternatively, the supplemental information may include an organization name or permitted security mechanism (e.g., secure sockets layer). The supplemental information may be analyzed to estimate the accuracy of the information in the trusted address lookup table. For example, a score may be calculated for the estimated accuracy of each entry in the table based on the supplemental information. When a score for an entry in the table falls below a predetermined level, the entry is flagged as dormant or removed from the table. The result is that entry of a security word to be provided to the destination address of that removed table entry will be tagged as a security violation.

The trusted address lookup table stored in database may be generated in various ways. In one example, the trusted address lookup table is generated manually. The password manager 105 may prompt the user to enter the trusted addresses and personal information individually in an initialization mode for the password manager 105.

The password manager 105 may generate the trusted address lookup table automatically. For example, the password manager 105 may detect when the endpoint device 101 accesses one or more remote systems requiring personal information for a connection. The detection may be based on the type of connection or fields in the data entry. The password manager 105 collects the personal information from the data entry to build the trusted address lookup table. The password manager 105 may be configured to verify the personal information. For example, the password manager 105 may prompt the user to enter the personal information again. The password manager 105 may prompt the user to confirm whether the personal information for each identified trusted address should be added to the trusted address lookup table.

The security agent 103 for scanning or monitoring web transactions or data entry of the user may be structured in various ways. In another example, the security agent 103 is at the kernel level. The security agent 103 may be implemented as a rootkit that subverts the operating system kernel. The security agent 103 may be impeded in a keyboard driver. The kernel based security agent may not be visible, accessible, or detectable to the user. In another example, the security agent 103 may be an application programming interface (API). The API may access available Windows APIs such as GetAsyncKeyState( ), GetForegroundWindow( ) to poll the state of the keyboard. The API based security agent is easily removed by other software. In another example, the security agent 103 may be memory based. The memory based security agent may access data tables in memory that are associated with a browser or other network application.

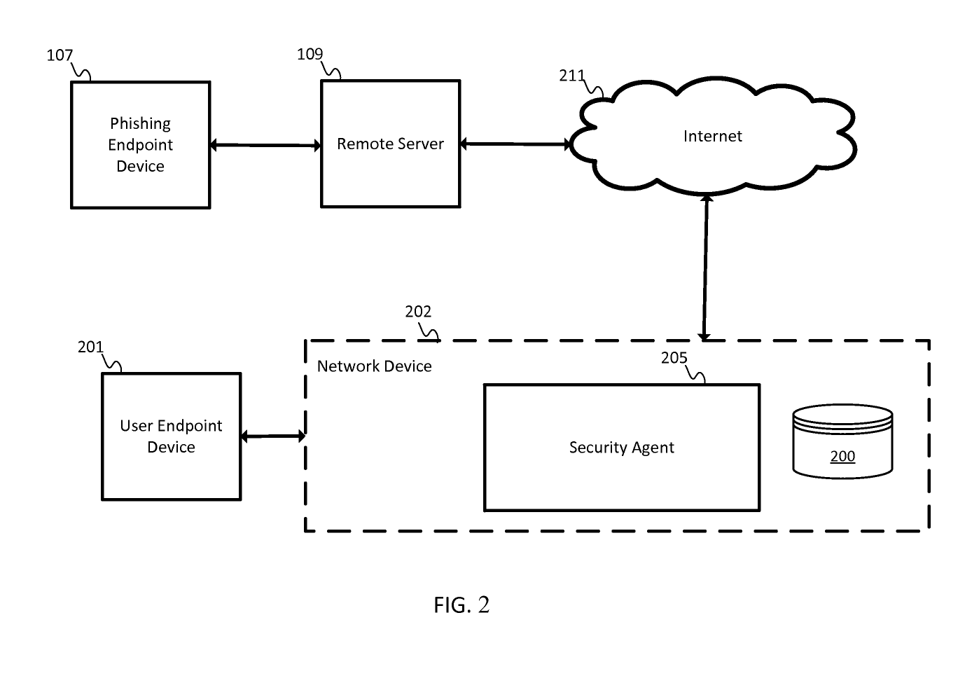

FIG. 2 illustrates another example system for phishing avoidance. The system includes a user endpoint device 201 and a network device 202. The network device 202 may be a server, a gateway, a router, or any device configured to send and receive data packets. The user endpoint device 201 may be connected to the network device 202 through a network. The network device 202 includes at least a security agent 205 and a database 200. The network device 202 may be connected to the remote server 109 and the phishing endpoint device 107 through the internet 211. Additional, different, or fewer components may be provided. For example, multiple endpoints may be connected to the remote server 109 and or the network device 202.

The user endpoint device 201 is configured to build, maintain, or update a list of authorized terms stored in the database 200. In one example, the network device 202 periodically (e.g., hourly, daily, weekly) polls endpoints for new or changed personal information. The personal information may include both the security words (e.g., usernames, passwords) and the authorized addresses (e.g., URLs, IP addresses) associated with the security words. Alternatively, a password manager on the endpoint automatically updates the network device 202 when any personal information is added or changed.

Through the security agent 205, the network device 202 is configured to examine data traffic. The data traffic may include all communication sent by the user endpoint device 201 and/or additional endpoints. The network device 202 is configured to identify a web transaction form the data traffic. The web transaction may include a user entered data or specific types of user entered data. The web transaction may include a hypertext transfer protocol secure (HTTPS) address, an encryption key, or a security certificate. The HTTPS address may include a layer of secure sockets layer or transport layer security having an encryption key and/or security certificate verification. The encryption key may be at least 80 bits long.

The network device 202 is configured to identify a security word from the web transaction. The web transaction may include multiple security words. The security words are usernames, passwords, security questions, security hints, security answers, or any other personal information associated with authorizing a secure web transaction. Example security questions include “What is the name of your first dog?” or “What is the make of your first car?” Example security answers include Fido and Ford. Example security hints include “Starts with an F” and “Rhymes with Chord.” The security agent 205 accesses the list of authorized terms that are associated with the user endpoint device 201 or with a particular user. The list of authorized terms includes the usernames, passwords, security hints, security answers, or any other personal information that the user has used to access internet services. The list of authorized terms may be generated automatically when the uses particular internet services or the list of authorized terms may be generated by the user when initializing the security agent 205.

The network device 202 is configured to query a list of authorized terms (e.g., the trusted address lookup table) for a security word from the web transaction. The query may determine exact matches or inexact matches. An inexact match occurs when the list of authorized terms includes an entry that is one or more characters different than the security word. The number of characters different may be referred to as an edit distance. The network device 202 is configured to compare the edit distance to an edit distance threshold. Example predetermined edit distance thresholds may be 1, 2, 3, or any value. The edit distance threshold may be entered by a user. The edit distance threshold may be a function of the score described above based on the supplemental information in the trusted address lookup table. For example, as an entry of personal information in the trusted address lookup table is older or the associated service has not been access for considerable amount of time, the edit distance threshold may be increased as a function of the amount of time.

The edit distance may be calculated (e.g., using the Levenshtein distance algorithm, the Hamming distance algorithm, or another algorithm) to determine a cost between two text strings. The cost may be calculated by assigning subcosts to each of the textual operations of insert a character, delete a character, and exchange a character as needed to convert an initial text string to a final text string. Pattern matching algorithms may be used to match the text strings.

When the security word is included in the list of authorized terms or within the edit distance threshold to one of the list of authorized terms, the network device 202 is configured to identify a destination address associated with the security word. If the destination address may be identified in memory as a trusted address, the network device 202 is configured to forward the web transaction. The process is transparent to both parties of the web transaction. However, if the destination is not a trusted address, the network device 202 is configured to block the web transaction or generate a warning message. The warning message may be sent to the user endpoint device 201 and/or the remote server 109. The warning message may indicate that the web transaction has been blocked because of potential security violation. The warning message may give the user endpoint device 201 the option of updating the trusted address table when the destination addresses is not a trusted address but the user would like to designate the destination address as trusted.

The network device 202 may also generate another type of warning message. The network device 202 may be configured to query a list of identified phishing entities with the destination address associated with the security word. The list of identified phishing entities includes known IP addresses or URLs of servers or computers that have been identified as sending phishing requests. The network device may be configured to generate a warning message when the destination is included in the list of identified phishing entities. The network device 202 may block the web transaction and all future communication with the destination address.

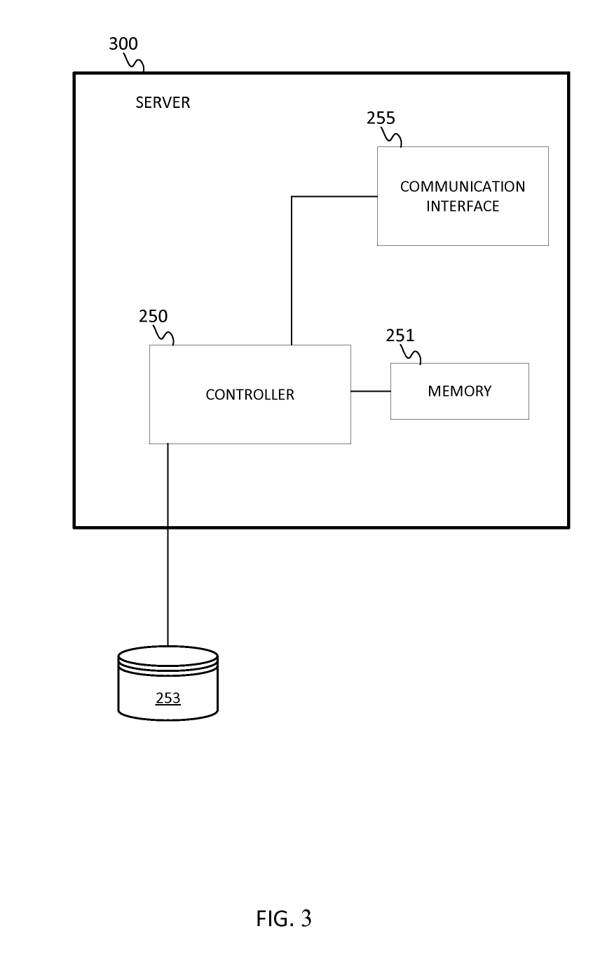

FIG. 3 illustrates an example computing device of the system of FIG. 1. The computing device may be the network device 202 or the user endpoint device 201. In an alternative embodiment, the computing device may be the remote server 109. That is, the remote server may analyze, forward, and block web transaction at the remote end as the web transaction are received the user's network. The computing device includes at least a memory 251, a controller 250, and a communication interface 255. In one example, a database 253 stores the trusted address lookup table described above. Additional, different, or fewer components may be provided. Different network devices may have the same or different arrangement of components.

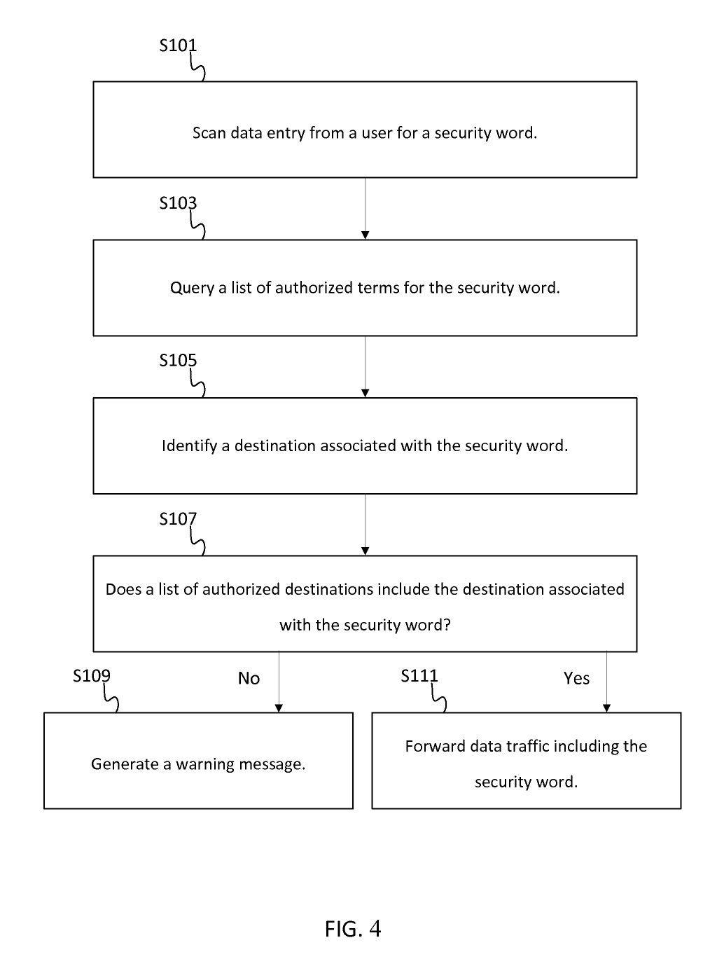

FIG. 4 illustrates an example flow chart for phishing avoidance using the computing device of FIG. 3. Additional, different, or fewer acts may be provided. The acts are performed in the order shown or other orders. The acts may also be repeated.

At act S101, the controller 250 is configured to monitor or scan data entry from a user for a security word. The controller may examine each character string in the data entry to identify login information or other credentials. Series of character strings may include full or partial security words.

At act S103, the controller 250 is configured to query a list of authorized terms for the security word. The list of authorized terms may be stored in the memory 251 or the database 253. The list of authorized terms may be derived from a password autocomplete application as software or a computer running software that organizes usernames, passwords and/or personal identification numbers (PINs). The list of authorized terms may be manually entered by the user upon initialization of the computing device or the phishing avoidance application. The list of authorized terms may be downloaded from trusted addresses using a web certificate or encryption technique.

At act S105, the controller 250 is configured to identify a destination associated with the entered security word. The memory 251 or the database 252 may associate trusted addresses with security words in a list of authorized destinations. One or more of the security words may be associated with multiple addresses. Some businesses use multiple URLs, and some users use the same security words for different businesses. In addition, the trusted address may be dynamic, changing over time as websites are moved, companies are acquired or rebranded, or for other reasons. When there is an update for one or more URLs, the first attempt to send data to that address results in a warning at the security agent 103. The security agent 103 may be configured to open a valid URL for the user to click. Upon accessing that URL, the security agent 103 resolves the address of that URL and adds or modifies the destination address in the database.

At act S107, the controller 250 is configured to determine whether the list of authorized destinations includes the destination addresses associated with the entered security word. When the destination address is included in the list of authorized destinations, the controller 250 forwards the data traffic including the security word to the next hop towards the destination address, at act S111. When the destination address is omitted from the list of authorized destinations, the controller 250 generates a warning message. The warning message may warn the user of the potential security violation but the data is forwarded anyway. The warning message may warn the user and drop the data packets including the security word. Alternatively, the data packets may be dropped and no message generated.

The controller 250 may include a general processor, digital signal processor, an application specific integrated circuit (ASIC), field programmable gate array (FPGA), analog circuit, digital circuit, combinations thereof, or other now known or later developed processor. The controller 250 may be a single device or combinations of devices, such as associated with a network, distributed processing, or cloud computing.

The memory 251 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the network device, such as a secure digital (SD) memory card.

In addition to ingress ports and egress ports, the communication interface may include any operable connection. An operable connection may be one in which signals, physical communications, and/or logical communications may be sent and/or received. An operable connection may include a physical interface, an electrical interface, and/or a data interface.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
scanning, using a processor, data entry from a user for a security word;
querying a list of authorized terms for the security word;
identifying, in response to the security word being included in the list of authorized terms, a destination address associated with the security word; and
querying a list of authorized destination addresses with the destination address associated with the security word.

2. The method of claim 1, further comprising:
generating, in response to the destination address associated with the security word being omitted from the list of authorized destination addresses, a warning message.

3. The method of claim 1, further comprising:
forwarding, in response to the destination address associated with the security word being included in the list of authorized destination addresses, data traffic including the security word.

4. The method of claim 1, further comprising:
querying a list of phishing entities with the destination address associated with the security word; and
generating, in response to the destination address associated with the security word being included in the list of phishing entities, a warning message.

5. The method of claim 1, wherein the security word includes a login name or a password.

6. The method of claim 1, wherein the security word includes a security credential or a security answer.

7. The method of claim 1, further comprising:
parsing data traffic for security transactions, wherein the security word is included in a security transaction with an identifier.

8. The method of claim 7, wherein the security transaction includes a hypertext transfer protocol post command.

9. An apparatus comprising:
a memory configured to store a plurality of personal information entries for a user and a plurality of trusted addresses for the user; and
a controller configured to determine whether data entry by the user includes one or more of the personal information entries and, in response to the data entry including one or more of the personal information entries, parse the data entry for a destination address of the data entry,
wherein the controller is configured to forward the data entry to the destination address when the destination address is included in the plurality of trusted addresses, and
wherein the controller is configured to generate an alert when the destination address is omitted from the plurality of trusted addresses.

10. The apparatus of claim 9, wherein the alert is a label inserted in the data entry that identifies the data entry as a security violation or a potential security violation.

11. The apparatus of claim 9, wherein the memory includes a list of suspected phishing entities, and wherein the controller is configured to determine whether the destination address is included in the list of suspected phishing entities.

12. The apparatus of claim 11, wherein the controller is configured to generate a warning message in response to the destination address being included the list of suspected phishing entities.

13. The apparatus of claim 11, wherein the controller is configured to block the data entry in response to the destination address being included the list of suspected phishing entities.

14. The apparatus of claim 9, wherein the one or more of the personal information entries includes a login name or a security credential.

15. The apparatus of claim 9, wherein the one or more of the personal information entries includes a password or a security answer.

16. A non-transitory computer readable medium including instructions that when executed are configured to cause a processer to:
identify a web transaction from data traffic;
identify, in response to entry of a security word, a destination address associated with the security word; and
query a list of authorized destination addresses with the destination address associated with the security word.

17. The non-transitory computer readable medium of claim 16, the instructions further configured to cause the processor to:
generate a warning message when the destination address associated with the security word is omitted from the list of authorized destination addresses.

18. The non-transitory computer readable medium of claim 16, the instructions further configured to cause the processor to:
forward the web transaction when the destination address associated with the security word is included in the list of authorized destination addresses.

19. The non-transitory computer readable medium of claim 16, wherein the web transaction includes a login name, a security credential, a password, or a security answer.

20. The non-transitory computer readable medium of claim 16, the instructions further configured to cause the processor to:
update the list of authorized destination addresses in response to notification that a trusted entity has changed an address.
